(19) United States
(12) Patent Application Publication
(10) Pub. No.: US 2003/0142961 A1
(43) Pub. Date: Jul. 31, 2003

(54) Optical recording medium, apparatus and method for playing the optical recording medium

(75) Inventors: Yeong-heon Oh, Seoul (KR); Young-ki Byun, Gyeonggi-do (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD., Suwon-city (KR)

(21) Appl. No.: 10/218,469

(22) Filed: Aug. 15, 2002

(30) Foreign Application Priority Data
Jan. 31, 2002 (KR) 2002-5648

(51) Int. Cl. H04N 5/781

(52) U.S. Cl. 386/95; 386/111; 386/125

(57) ABSTRACT

An optical recording medium includes a start position of a caption and a marking at specific areas of contents. An apparatus and a method of playing the optical recording medium includes displaying a normal caption by moving an optical head of the apparatus to the start position of an effective caption and decoding from the start position while playing the contents. That is, the method of playing the optical recording medium includes analyzing a stream read out from the optical recording medium and detecting whether an identification code and information about the start position of the caption is recorded on a preliminary area of the stream, transferring to the start position of the caption recorded on the preliminary area by using the result of the detecting, and performing a signal process operation from the start position, so as to display the caption on a corresponding image of the optical recording medium being played back. Accordingly, a controller of the apparatus starts operating from the start position of the effective caption stored in a specific area to decode and display the effective caption, so as to normally display the caption while playing the optical recording medium.

### CROSS-REFERENCE TO RELATED APPLICATIONS

This application claims the benefit of Korean Patent Application No. 2002-5648 filed on Jan. 31, 2002, in the Korean Industrial Property Office, the disclosure of which is incorporated herein by reference.

### BACKGROUND OF THE INVENTION

1. Field of the Invention

The present invention relates to an optical recording medium, and an apparatus and a method of playing the optical recording medium. More particularly, the present invention relates to an optical recording medium having a start position of a caption and a marking at specific areas of contents, and an apparatus and a method of playing the recording medium to display a normal caption by moving an optical head to the start position of the caption and decoding from the start position while playing the contents.

2. Description of the Related Art

Generally, a digital video disk (DVD) has the same size as a compact disk (CD) having a diameter of 12 cm and a thickness of 1.2 mm. However, as a recording medium, the DVD can record data as much as 7 times more than the CD. A CD can store an amount of data as much as 74 minutes, which corresponds to 688 MB. A DVD can store an amount of data of about 4.7 GB to 17 GB depending on the types of a playback surface, which can be single-sided or double-sided, each of which allows a single layer or multiple layers.

To store a large amount of data, DVDs use a motion picture expert group (MPEG)-2 compression method which places more weight on image quality, and not a MPEG-1 compression method which places more weight on compression degree while degrading the image quality. Accordingly, DVDs provide a high image quality as compared to CDs.

In addition, an extra area is allotted to store information such as audio information and caption information, and various set-up menus. Consequently, DVDs may provide a conversation type progression function by which contents are progressed according to selections of a user, a multi-language caption function by which a maximum of, for example, 32 languages can be stored, a multi-language function by which sound tracks in a maximum of, for example, 8 languages are provided, a digital surround function by which sound is output through, for example, 6 speakers such as left and right front, left and right rear, center, and woofer speakers, a multi-story function by which the user may select the story of a movie from preset stories, a multi-angle function by which a viewer may select a scene captured at an angle from the scenes captured at various angles, and a parental lock function by which different grades are established for each scene for restricting the viewers.

A subtitle menu is included in the set-up menus provided by DVDs to establish the kind of language and caption. The subtitle menu is used efficiently and frequently to appreciate the DVDs using various languages. The subtitle menu includes captions having explicit periods. In other words, a specific scene is synchronized with a specific caption during the period to display the caption on a screen. Accordingly, for decoding reasons, the caption data has to be decoded beginning from a start position. In the case that an optical head of a player moves to a middle of a caption data area, caption data cannot be decoded.

### SUMMARY OF THE INVENTION

Accordingly, it is an object of the present invention to provide an optical recording medium having information about a start position of a caption in a specific area of a content, so as to normally display the caption on a screen while playing back the content.

Another object of the present invention is to provide an apparatus which plays an optical recording medium so as to display a normal caption by moving an optical head to a start position of a caption, which is recorded on a specific area of a content of the optical recording medium, to decode the caption from the start position.

Yet another object of the present invention is to provide a method of playing an optical recording medium so as to display a normal caption by moving an optical head (a pickup unit) to a start position of a caption, which is recorded on a specific area of a content of the optical recording medium, to decode the caption from the start position.

Additional objects and advantages of the invention will be set forth in part in the description which follows and, in part, will be obvious from the description, or may be learned by practice of the invention.

To achieve the above and other objects of the present invention, there is provided an optical recording medium having a marking and information about a start position of a caption in a preliminary area of a stream of content, so as to normally display the caption while playing the stream of content.

The marking may be an identification code which informs that the start position of the caption is recorded on the recording medium.

The specific marking and information about the start position of the caption may be recorded on preliminary areas of predetermined information tables of the recording medium, wherein the predetermined information tables are used to play the recording medium.

The specific marking and information about the start position of the caption may be recorded on a preliminary area of a predetermined presentation control information (PCI) packet or a data search information (DSI) packet of the recording medium, wherein the PCI or DSI packet is used to play the recording medium.

To achieve the above and other objects of the present invention, there is also provided an apparatus which plays an optical recording medium having an identification code and information about a start position of a caption on a preliminary area of a stream of content, comprising a signal processing unit which reads out the identification code and the information about the start position of the caption recorded on the preliminary area and the stream of content from the recording medium, and performs a signal processing operation to display the caption, and a controller which controls displaying of the caption by analyzing the stream of content read out by the signal processing unit and detecting whether the information about the start position of the caption exists in the preliminary area, so as to transfer an optical head of the apparatus to the start position of the caption recorded on the preliminary area.

The controller may detect whether the start position of the caption is recorded according to existence/absence of the identification code, which is recorded on the preliminary area of the recording medium.

The identification code may inform (indicate) that the information about the start position of the caption is recorded on the recording medium.

The identification code and the information about the start position of the caption detected by the controller may be detected from preliminary areas of predetermined information tables of the recording medium, wherein the predetermined information tables are used to play the recording medium.

The identification code and information about the start position of the caption detected by the controller may be detected from a preliminary area of a predetermined PCI packet or a DSI packet of the recording medium, wherein the PCI or DSI packet is used to play the recording medium.

To achieve the above and other objects of the present invention, there is further provided a method of playing an optical recording medium using a player unit having a pickup unit, the method comprising analyzing a stream read out from the recording medium and detecting whether an identification code and information about a start position of a caption is recorded on a preliminary area of the stream, transferring the pickup unit to the start position of the caption recorded on the preliminary area in response to existence of the identification code and the information, and performing a signal processing operation to display the caption on a corresponding image of the recording medium being played back.

The method may detect whether the start position of the caption is recorded on the recording medium according to existence/absence of the identification code recorded on the preliminary area of the recording medium.

The identification code may inform that the information about the start position of the caption is recorded on the recording medium.

The identification code and the information about the start position of the caption may be detected from preliminary areas of predetermined information tables of the recording medium, wherein the predetermined information tables are used to play the recording medium.

The identification code and the information about the start position of the caption may be detected from a preliminary area of a predetermined PCI packet or a DSI packet of the recording medium, wherein the PCI or DSI packet is used to play the recording medium.

### BRIEF DESCRIPTION OF THE DRAWINGS

These and other objects and advantages of the present invention will become apparent and more readily appreciated from the following description of the embodiments, taken in conjunction with the accompanying drawings of which:

FIG. 1 shows a signal format depicting an optical recording medium according to an embodiment of the present invention;

FIG. 2 is a block diagram presenting the configuration of an apparatus which plays the optical recording medium shown in FIG. 1; and

FIG. 3 is a flowchart illustrating a method of playing the optical recording medium shown in FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

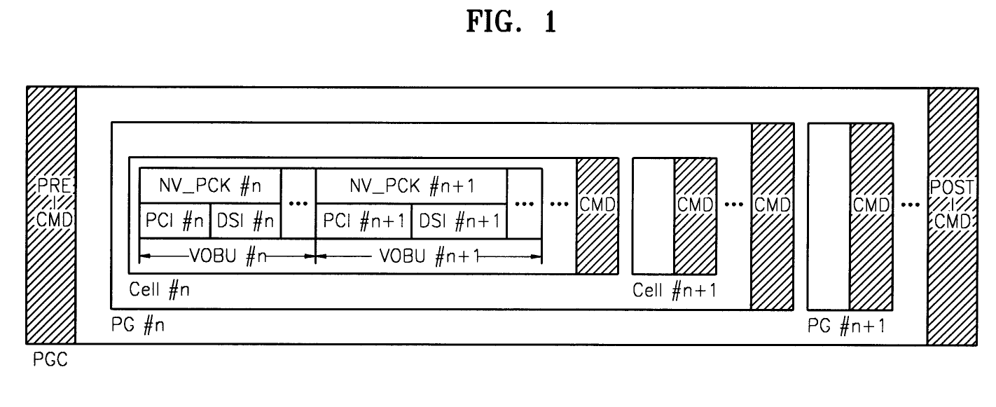

FIG. 1 shows a signal format depicting an optical recording medium according to an embodiment of the present invention.

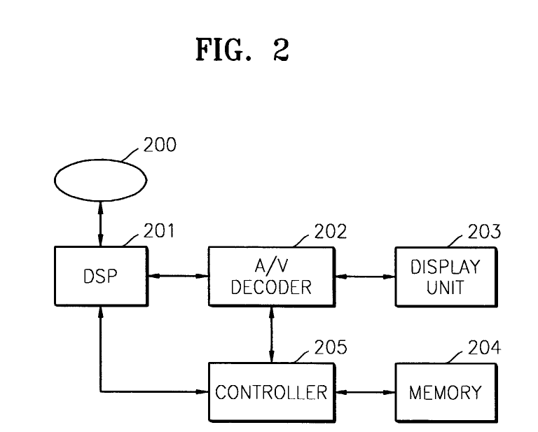

FIG. 2 shows a block diagram of an apparatus which plays the optical recording medium 200 of the present invention. The apparatus for receiving the optical recording medium 200 includes a digital signal processor (DSP) 201, an audio/video (A/V) decoder 202, a display unit 203, a memory 204, and a controller 205. The DSP 201 and A/V decoder 202 will be referred to as a signal processing unit.

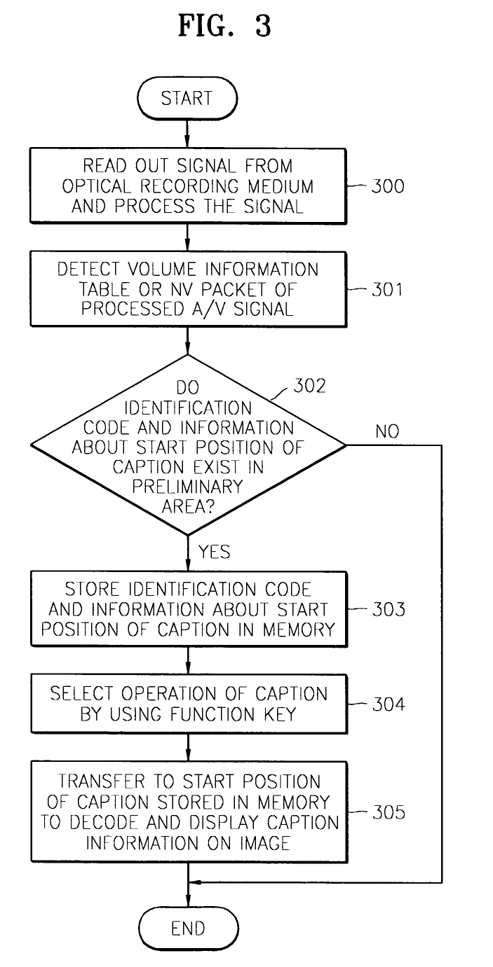

FIG. 3 shows a flowchart illustrating a method of playing the optical recording medium (“optical disk”) 200 according to the present invention. The method includes reading and processing A/V signals from the optical recording medium (300), detecting a volume information table or a navigation (NV) packet regarding the processed A/V signals (301), determining existence of information about an identification code and a start position of a caption in a preliminary area (302), storing the information about the identification code and the start position of the caption in a memory (303), selecting an operation of a specific caption by using a specific function key (304), and moving an optical head of a player to the start position of the caption stored in the memory to decode and display caption data on a screen (305).

In FIG. 1, with reference to FIG. 2, a video object unit VOBU is the smallest unit of a moving picture expert group (MPEG) stream, which is recorded on or played from the optical disk 200. A specific number of VOBUs forms a cell, and a specific number of cells forms a page (PG). A specific number of PGs forms a page chain (PGC), which is the largest unit of the MPEG stream.

The VOBU is formed of a specific number of NV packets NV_PCK. In this case, the NV packets NV_PCK are formed of presentation control information (PCI) packets and data search information (DSI) packets. The PCI packet formed of, for example, 60 bytes stores presentation control information such as highlight information, VOBU category information, and non seamless angle information while having a preliminary area of 32 bytes. The DSI packet formed of, for example, 1017 bytes stores data search information such as VOBU category information and seamless angle information while having a preliminary area of 471 bytes.

An identification code and information about a start position of an effective caption are inserted into the preliminary areas of the PCI and DSI packets, as the contents are recorded on the optical disk 200. Therefore, where the contents are played, the optical head of the player is transferred by the controller 205 to the start position of the effective caption to decode caption data and display caption information on a corresponding image. In this case, four bytes are allotted for the information about the start position of the effective caption, which is stored in the preliminary area.

The identification code, i.e., a specific marking, reveals the existence of the information about the start position of the effective caption in the optical disk 200.

In addition, the optical disk 200 includes a volume information table in which information to play the optical disk 200 is stored. The volume information table includes a video set information (VTSI) management table and a video manager information (VMGI) management table to store the identification code and the information about the start position of the effective caption in preliminary areas of the VTSI and VMGI management tables.

The VTSI management table formed of, for example, 2047 bytes stores information about the establishment of video titles. The VTSI management table includes preliminary areas at 16-27, 232-255, 268-339, 348-511, 580-595, 790-791, and 984-2047 bytes to record the identification code and the information about the start position of the effective caption. The VMGI management table formed of, for example, 2291 bytes stores information about the management of videos. The VMGI management table includes preliminary areas at 16-27, 48-61, 104-127, 136-191, 224-255, 268-339, and 348-1023 bytes to record the identification code and the information about the start position of the effective caption.

An apparatus and method of playing the optical disk 200 into which the information about the start position of the effective caption and the identification code thereof are embedded will be further described below with reference to FIGS. 2 and 3.

Signals are read out from an optical recording medium, the optical disk 200, and processed in operation 300. That is, an A/V signal is read out from the optical disk 200 by a pickup (not shown), and descrambled and eight-to-fourteen modulated (EFM) in the DSP 201.

A volume information table of the processed A/V signal or an NV packet is analyzed in the DSP 201, so as to determine the existence of an identification code and information about a start position of an effective caption in a preliminary area in operations 301 and 302. The controller 205 analyzes the volume information table of the DSP processed A/V signal or the NV packet so as to determine whether the information about the start position of the effective caption exists according to the existence of the identification code.

In the case that the information about the start position of the effective caption exists in the preliminary area of the volume information table or the NV packet, the information is stored in the memory 204 in operation 303.

Where the controller 205 determines that the information about the start position of the effective caption is recorded on the optical disk 200 by using the identification code, the controller 205 informs a user of the existence of the information and waits for input of a specific function key so as to perform a caption display operation.

Where the user inputs the specific function key to select the caption display operation in operation 304, the controller 205 transfers an optical head to the start position of the caption by using the information about the start position of the effective caption stored in the memory 204. Thereafter, the controller 205 decodes caption data and outputs the decoded caption data to the display unit 203 in operation 305. The A/V signal and the caption data are decoded in the A/V decoder 202 and output to the display unit 203.

According to the present invention, the controller 205 starts operating from the start position of the effective caption stored in a specific area to decode and display the effective caption, so as to normally display the caption while playing the optical recording medium.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An optical recording medium comprising:
a stream of content; and
a marking and information about a start position of a caption in a preliminary area of the stream of content, so as to normally display the caption while playing the stream of content.

2. The optical recording medium of claim 1, wherein the marking is an identification code which informs that the start position of the caption is recorded on the recording medium.

3. The optical recording medium of claim 1, wherein the marking and the information about the start position of the caption are recorded on preliminary areas of predetermined information tables of the recording medium, wherein the predetermined information tables are used to play the recording medium.

4. The optical recording medium of claim 1, wherein the marking and the information about the start position of the caption are recorded on a preliminary area of a presentation control information (PCI) packet and/or a data search information (DSI) packet of the recording medium, wherein the PCI or DSI packet is used to play the recording medium.

5. An apparatus for playing an optical recording medium having an identification code and information about a start position of a caption recorded on a preliminary area of a stream of content, comprising:
a signal processing unit which reads out the identification code and the information about the start position of the caption and the stream of content from the recording medium, and performs a signal processing operation to display the caption; and
a controller which controls displaying of the caption by analyzing the stream of content read out by the signal processing unit and detects whether the information about the start position of the caption exists in the preliminary area, so as to transfer an optical head of the apparatus to the start position of the caption recorded on the preliminary area.

6. The apparatus of claim 5, wherein the controller detects whether the start position of the caption is recorded according to existence/absence of the identification code, which is recorded on the preliminary area of the recording medium.

7. The apparatus of claim 6, wherein the identification code informs that the information about the start position of the caption is recorded on the recording medium.

8. The apparatus of claim 5, wherein the identification code and the information about the start position of the caption detected by the controller are detected from preliminary areas of predetermined information tables of the recording medium, wherein the predetermined information tables are used to play the recording medium.

9. The apparatus of claim 5, wherein the identification code and the information about the start position of the caption detected by the controller are detected from a preliminary area of a presentation control information (PCI) packet and/or a data search information (DSI) packet of the recording medium, wherein the PCI or DSI packet is used to play the recording medium.

10. A method of playing an optical recording medium using a player unit having a pickup unit, the method comprising:
analyzing a stream read out from the recording medium and detecting whether an identification code and information about a start position of a caption are recorded on a preliminary area of the stream;
transferring the pickup unit to the start position of the caption recorded on the preliminary area in response to existence of the identification code and the information; and
performing a signal processing operation from the start position to display the caption on a corresponding image of the recording medium being played back.

11. The method of claim 10, wherein the detecting of whether the identification code and the information are recorded includes detecting whether the start position of the caption is recorded according to existence/absence of the identification code recorded on the preliminary area of the recording medium.

12. The method of claim 11, wherein the identification code informs that the information about the start position of the caption is recorded on the recording medium.

13. The method of claim 10, wherein the detecting of whether the identification code and the information are recorded includes detecting the identification code and the information about the start position of the caption from preliminary areas of predetermined information tables of the recording medium, wherein the predetermined information tables are used to play the recording medium.

14. The method of claim 10, wherein the detecting of whether the identification code and the information are recorded includes detecting the identification code and the information about the start position of the caption from a preliminary area of a presentation control information (PCI) packet and/or a data search information (DSI) packet of the recording medium, wherein the PCI or DSI packet is used to play the recording medium.

15. The optical recording medium of claim 1, wherein the stream of content is a moving picture expert group (MPEG) stream.

16. The optical recording medium of claim 15, wherein the MPEG stream includes a navigation packet having a PCI and DSI packets, wherein the marking and the information about the start position of the caption is recorded on a preliminary area of the PCI and/or DSI packets.

17. The optical recording medium of claim 1, wherein the marking indicates existence of the information about the start position of the caption in the recording medium.

18. The optical recording medium of claim 3, wherein:
the predetermined information tables are volume information tables,
each of the volume information tables includes a video set information (VTSI) management table and a video manager information (VMGI) management table, and
the marking and the information about the start position of the caption are recorded on a preliminary area of the VTSI and/or VMGI management tables.

19. The apparatus of claim 5, further comprising:
a memory which stores the identification code and the information about the start position of the caption read out from the recording medium; and
a display unit which displays the caption and the stream of content.

20. The apparatus of claim 19, wherein the signal processing unit includes:
a digital signal processor which analyzes the stream of content; and
an audio/video decoder which decodes and outputs the stream of content and the caption to the display unit.

21. The method of claim 10, wherein:
the analyzing of the stream read out includes:
reading and processing the stream read out from the recording medium; and
detecting one of a volume information table and a navigation packet of the stream, and
the detecting of whether the identification code and the information are recorded on the preliminary area includes storing the identification code and the information in a memory in response to existence of the identification code and the information in a preliminary area of the volume information table or the navigation packet.

22. The method of claim 10, wherein the transferring to the start position of the caption includes obtaining an input signal which directs the player unit to display the caption.

23. An optical recording medium comprising:
a content which includes a navigation packet; and
an information table, wherein:
the content forms an image, and
at least one of the navigation packet and the information table includes a marking and information about a start position of a caption corresponding to the image, so as to normally display the caption while displaying the image.

24. The optical recording medium of claim 23, wherein the marking and the information are recorded on a preliminary area of the navigation packet or the information table.

25. The optical recording medium of claim 24, wherein the marking is an identification code which indicates the existence of the information about the start position of the caption on the recording medium.

26. An optical recording medium for recording/reproducing data using a player unit, comprising a signal format which includes a marking and information about a start position of a caption in a preliminary area of the signal format, wherein the information directs the player unit to the start position of the caption so as to normally display the caption while displaying a corresponding image of the signal format.

27. The optical recording medium of claim 26, wherein the marking is an identification code which indicates the existence of the information about the start position of the caption on the recording medium
